(19) United States
(12) Patent Application Publication
(10) Pub. No.: US 2010/0039341 A1
(43) Pub. Date: Feb. 18, 2010

(54) RADAR TRANSMISSION AND RECEPTION DEVICE

(75) Inventors: Philippe Vicariot, Le Relecq Kerhuon (FR); Michel Rungoat, Brest (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/513,893

(22) PCT Filed: Nov. 7, 2007
(86) PCT No.: PCT/EP2007/062020

§ 371 Date: Aug. 13, 2009

(30) Foreign Application Priority Data
Nov. 7, 2006 (FR) 06 09710

(51) Int. Cl. H01Q 3/00

(52) U.S. Cl. 343/765

(57) ABSTRACT

The invention relates to a radar transmission and reception device comprising a movable antenna (1). The invention is particularly useful in aircraft-borne radars making it possible to obtain information on meteorology. The antenna (1) can be move in rotation about two substantially concurrent axes (2, 3). The antenna (1) is intended to transmit and/or to receive an electromagnetic wave. The device furthermore comprises an electronic module (4) linked to the antenna (1) by a waveguide, the electronic module (4) ensuring the processing of the electromagnetic wave received and/or the generation of the electromagnetic wave transmitted. The electronic module (4) is secured to the antenna (1).

### CROSS-REFERENCE TO RELATED APPLICATIONS

The present Application is based on International Application No. PCT/EP2007/062020, filed on Nov. 7, 2007, which in turn corresponds to French Application No. 06 09710 filed on Nov. 7, 2006, and priority is hereby claimed under 35 USC §119 based on these applications. Each of these applications are hereby incorporated by reference in their entirety into the present application.

### BACKGROUND OF THE INVENTION

The invention relates to a radar transmission and reception device comprising a movable antenna. The invention is particularly useful in aircraft-borne radars making it possible to obtain information on meteorology. This type of radar comprises an antenna that can move in rotation. This antenna is protected inside a radome. The antenna is generally situated at the nose of the aircraft and the skin of the aircraft forms the radome.

The radar antenna is linked by a waveguide to an electronic module generating and/or receiving an RF electromagnetic wave. It is known to site the electronic module on a fixed part of the radar. This arrangement, fixed module and movable antenna, entails implementing the waveguide by means of a revolving joint.

The rotation of the antenna generally takes place about axes situated at the rear of the antenna so as not to disturb the active part of the antenna. Moreover, the antenna must be balanced in its movements. It is then expedient to make a movable rig comprising in addition to the antenna, at least one flyweight situated to the rear of the axes of rotation in such a way that the centre of gravity of the movable rig is situated on the axis of rotation of the antenna if the latter is movable only about one axis or is situated at the intersection of the axes of rotation if the antenna is movable about several axes.

The presence of this inert flyweight tends to increase the mass on board the aircraft without any genuine functional contribution.

### SUMMARY OF THE INVENTION

The invention is aimed at alleviating these problems by proposing that the flyweight of the movable rig be replaced with the electronic module of the radar.

For this purpose, the subject of the invention is a radar transmission and reception device comprising an antenna that can move in rotation about two substantially concurrent axes, the antenna being intended to transmit and/or to receive an electromagnetic wave, an electronic module linked to the antenna by a waveguide, the electronic module ensuring the processing of the electromagnetic wave received and/or the generation of the electromagnetic wave transmitted, characterized in that the electronic module is secured to the antenna.

It is often tricky to devise an electronic module with defined functions while complying with a predefined mass and predefined position of the centre of gravity of the module. Specifically, when the module is made on the basis of printed circuit boards, the position of components making it possible to fulfil the functions of the module complies essentially with electrical constraints such as for example the fact of avoiding inordinate lengths of certain tracks of the printed circuit or else the fact of moving certain functional blocks away from the module so as to avoid mutual electromagnetic interference. It is for this reason that, in a known manner, the use of a flyweight has been preferred in order to balance the movable rig. The invention runs counter to this preconception by placing the electronic module in the movable rig.

An advantage of the invention is to allow simplification of the waveguide linking the electronic module to the antenna. Specifically, when the electronic module belongs to the fixed part of the radar, the RF electromagnetic wave is made to pass between the module and the antenna through a revolving joint comprising a waveguide part. By integrating the module into the movable rig it is possible to dispense with the waveguide part of the revolving joint. Only links with lower frequencies than those of the RF waves not requiring any waveguide are then retained in the revolving joint. The waveguide linking the electronic module and the antenna becomes fixed, with no movable part. It is therefore much simpler to make.

It is also possible to completely do away with a revolving joint by making the low-frequency links with the aid of movable cables or wires.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a first embodiment of the invention;

FIG. 2 represents a second embodiment of the invention.

For the sake of clarity, the same elements will bear the same tags in the various figures.

### DETAILED DESCRIPTION OF THE PREFERRED EMBODIMENT

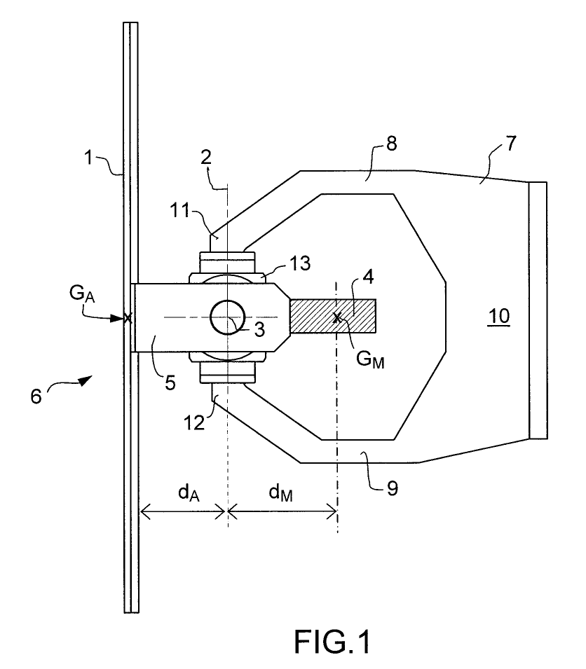

FIG. 1 represents a radar transmission and reception device comprising an antenna 1 that can move in rotation about two substantially concurrent axes 2 and 3. In FIG. 1, the axis 2 is vertical and the axis 3 is upright. Advantageously the axes 2 and 3 are concurrent. The device also comprises an electronic module 4 linked to the antenna 1 by a waveguide, the module ensuring the processing of the electromagnetic wave received and/or the generation of the electromagnetic wave transmitted.

The antenna 1 and the module 4 are fixed to a support 5. The antenna 1, the module 4 and the support 5 form a rig 6 movable in rotation about the axes 2 and 3 with respect to a mount 7. The waveguide is essentially made in the support 5 so as to link the antenna 1 to the module 4. The mount 7 comprises two arms 8 and 9 linked together by a hefty part 10 allowing the device to hook onto a carrier such as an aircraft for example. The arms 8 and 9 each comprise a free end, respectively 11 and 12 between which the axis 2 runs. A cross-brace 13 is articulated both to the axis 2 and to the axis 3. The support 5 can, like the mount 7, comprise two arms between which the axis 3 runs. The waveguide can be made in one of the arms of the support 5.

A motorization system, not represented in FIG. 1, advantageously makes it possible to orient the movable rig about the axes 2 and 3.

The shape and the position of the module in the movable rig are such that the centre of gravity of the movable rig 6 is substantially situated at the point of intersection of the axes 2 and 3. Thus, the effort that must be provided by the motorization system to move the movable rig 6 is reduced. This arrangement is also beneficial when the carrier is subjected to accelerations greater than that of gravity. The risks of untimely movement of the antenna 1, which would disturb the transmission and/or the reception of the antenna 1, are thus limited.

More precisely, it is possible to neglect the effect of the support 5 in the balancing of the movable rig 6. Specifically, the support 5 runs, by dint of its function, in the vicinity of the point of intersection of the axes 2 and 3. It is therefore possible to balance the movable rig 6 while taking account only of the antenna 1 and of the module 4. Stated otherwise, the product of the mass of the antenna 1 times a distance d_{A} separating the centre of gravity G_{A} of the antenna 1 from the point of intersection of the axes 2 and 3 is substantially equal to the product of the mass of the electronic module 4 times a distance d_{M} separating the centre of gravity G_{M} of the electronic module 4 from the point of intersection of the axes 2 and 3.

To facilitate the positioning of the centre of gravity G_{M}, provision may be made for means for adjusting the distance separating the centre of gravity of the electronic module 4 from the point of intersection of the axes 2 and 3. These adjusting means comprise for example shims making it possible to move the module 4 away from the point of intersection of the axes 2 and 3.

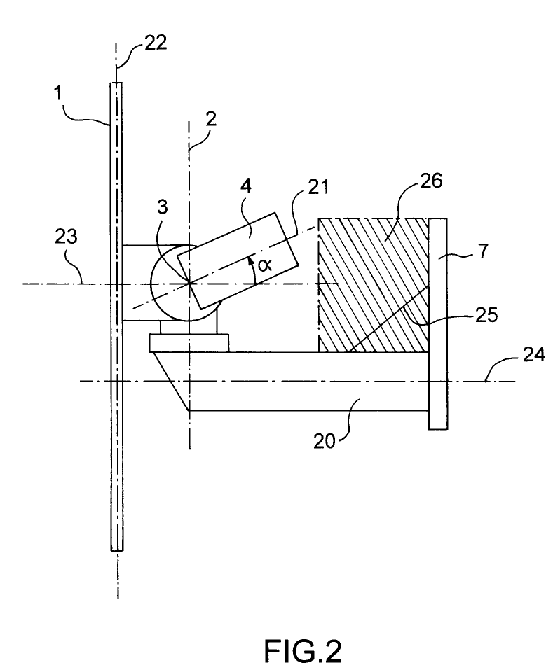

FIG. 2 represents another embodiment of the device in which the mount 7 comprises only a single arm 20 instead of the two arms 8 and 9 of the embodiment of FIG. 1. This arrangement makes it possible to increase the angular travel of the antenna 1 about the axis 3.

It is possible to define a principal direction 21 of the electronic module 4. The electronic module 4 is for example formed of an assemblage of several rectangular printed circuit boards assembled parallel to one another. The principal direction 21 of the electronic module 4 is for example perpendicular to the largest side of the printed circuits. The principal direction 21 can also be parallel to the largest side of the printed circuits. Moreover, the antenna 1 is generally substantially plane and it is therefore possible to define a principal plane 22 of the antenna 1. Advantageously, the principal direction 21 of the electronic module 4 is offset angularly by an angle a with respect to a direction 23 perpendicular to the principal plane 22 of the antenna 1.

Advantageously, the arm 20 is substantially spindly and runs along a principal direction 24. The angular offset a between the principal direction 21 of the electronic module 4 and the direction 23 is oriented so as to increase the angular travel of the antenna 1 in relation to one of its axes of rotation 3. The axis 3 is perpendicular to the plane of FIG. 2. This angular offset a makes it possible to increase the dimensions of a section of the arm 20, dimensions measured perpendicularly to the axis 24. By increasing the dimensions of this section, the rigidity of the arm 20 and more generally of the mount 7 is increased. This makes it possible to improve the precision in the movements of the antenna 1 about its axes of rotation 2 and 3. To further improve the rigidity of the mount 7, it is possible to arrange a rib 25 at the base of the arm 20 so as to limit its droop along the axis 24.

This embodiment using only a single arm 20 also makes it possible to increase the dimensions of a location 26 available for siting a second electronic module secured to the mount 7 and connected to the first electronic module 4. The location 26 is portrayed by hatching surrounded by a chain-dotted line.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Radar transmission and reception device comprising an antenna that can move in rotation about two substantially concurrent axes, the antenna being intended to transmit and/or to receive an electromagnetic wave, an electronic module linked to the antenna by a waveguide, the electronic module ensuring the processing of the electromagnetic wave received and/or the generation of the electromagnetic wave transmitted, wherein the electronic module is secured to the antenna.

2. The device according to claim 1, wherein the antenna comprises a centre of gravity and the electronic module comprises a centre of gravity, and wherein the product of the mass of the antenna times a distance separating the centre of gravity of the antenna from the point of intersection of the axes is substantially equal to the product of the mass of the electronic module times a distance separating the centre of gravity of the electronic module from the point of intersection of the axes.

3. The device according to claim 2, wherein comprising means for adjusting the distance separating the centre of gravity of the electronic module from the point of intersection of the axes.

4. The device according to claim 1, wherein a principal direction of the electronic module is offset angularly with respect to a direction perpendicular to a principal plane of the antenna.

5. The device according to claim 4, wherein the antenna is movable with respect to a mount, wherein the mount comprises an arm running along a principal direction and wherein the angular offset is oriented so as to increase the angular travel of the antenna in relation to one of its axes of rotation.

6. The device according to claim 5, wherein the mount comprises only a single arm.

7. The device according to claim 2, wherein a principal direction of the electronic module is offset angularly with respect to a direction perpendicular to a principal plane of the antenna.

8. The device according to claim 7, wherein the antenna is movable with respect to a mount, wherein the mount comprises an arm running along a principal direction and wherein the angular offset is oriented so as to increase the angular travel of the antenna in relation to one of its axes of rotation.

9. The device according to claim 8, wherein the mount comprises only a single arm.

10. The device according to claim 3, wherein a principal direction of the electronic module is offset angularly with respect to a direction perpendicular to a principal plane of the antenna.

11. The device according to claim 10, wherein the antenna is movable with respect to a mount, wherein the mount comprises an arm running along a principal direction and wherein the angular offset is oriented so as to increase the angular travel of the antenna in relation to one of its axes of rotation.

12. The device according to claim 11, wherein the mount comprises only a single arm.
